(19) United States
(12) Patent Application Publication
(10) Pub. No.: US 2024/0065819 A1
(43) Pub. Date: Feb. 29, 2024

(54) ELECTRIC TOOTHBRUSH FOR PETS

(71) Applicant: INAE YU, Seoul (KR)

(72) Inventor: INAE YU, Seoul (KR)

(21) Appl. No.: 17/901,787

(22) Filed: Sep. 1, 2022

(30) Foreign Application Priority Data
Aug. 30, 2022 (KR) 10-2022-0109116

(51) Int. Cl. A61D 5/00

(52) U.S. Cl. CPC A61D 5/00

(57) ABSTRACT

An electric toothbrush for pets includes a housing configured to have a button unit, a power-supply unit configured to supply power, a toothbrush head connected to the housing, a vibration unit configured to vibrate the toothbrush head using the supplied power, and a MCU configured to control the vibration unit. The MCU controls the vibration unit to vibrate with a first vibration pattern, based on an input signal generated when a button included in the button unit is selected.

This application claims the benefit of Korean Patent Application No. 10-2022-0109116, filed on Aug. 30, 2022, which is hereby incorporated by reference as if fully set forth herein.

### BACKGROUND OF THE INVENTION

### Field of the Invention

The present disclosure relates to an electric toothbrush for pets.

### Discussion of the Related Art

Companion animals (hereinafter referred to as pets) have been sharing lifetimes with humans since prehistoric times for the purpose of intimate fellowship or emotional sharing with humans. As the traditional society where human exchanges were continuously made is dismantled and the feeling of loneliness in modern society increases, interest in pets that can satisfy human needs, such as intimate fellowship, emotional sharing, and exchange with humans, is gradually increasing. Recently, due to the dissolution or change of social structure and family relationships, single-person households of single men and women or elderly households living alone with the advent of the aging era are rapidly increasing. In this situation, the demand for companion animals (or pets) to be adopted as new families for solving loneliness of modern humans is increasing rapidly.

Accordingly, various bath products and beauty products for keeping pets clean have recently been developed and introduced to the market. In particular, brushing teeth of pets is also a subject of interest to people.

In particular, cats generally dislike having their teeth brushed. However, studies have shown that cats who do not have their teeth brushed have a one-third reduction in lifespan. In fact, 80% of cats 3 years of age and older are infected with dental diseases, and dental diseases such as periodontal disease, stomatitis, and odontolysis lesions lead to systemic diseases such as heart disease, heart failure, brain disease, bacteremia and infections caused by toxins.

For cats who do not like to have their teeth brushed, toothpaste supplements or immune supplements for cats are being developed and marketed. However, if such supplements are used to solve cat's oral hygiene problems, a person who raises the cat has difficulty in recognizing the cat's health state. In addition, if the cat takes such supplements for a long time, the supplements may put strain on the cat's kidneys and liver so that there is a high possibility of causing problems with kidney and liver diseases that are difficult to recover from.

It has not been long since the domestic market for cat products was created. Since toothpaste supplements for cats have recently been developed and released, even though a user can take care of cat's teeth through snacks such as supplements, many veterinarians are recommending using physical teeth brushing for cats without the use of toothpaste due to the above-described problems.

In other words, in dental lectures by the Veterinary Animals Dental Association, etc., it is recommended that the best way to brush cats' teeth is to shake the cat's periodontal sacs (i.e., bacterial sacs between the cats' teeth and gums).

### SUMMARY OF THE INVENTION

Accordingly, the present disclosure is directed to an electric toothbrush for pets that substantially obviates one or more problems due to limitations and disadvantages of the related art.

An object of the present disclosure is to provide an electric toothbrush for pets, which can more easily brush teeth of pets.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an electric toothbrush for pets may include a housing configured to have a button unit, a power-supply unit configured to supply power, a toothbrush head connected to the housing, a vibration unit configured to vibrate the toothbrush head using the supplied power, and a c Micro Controller Unit(MCU) configured to control the vibration unit. The MCU controls the vibration unit to vibrate with a first vibration pattern, based on an input signal generated when a button included in the button unit is selected.

The first vibration pattern may be a vibration pattern in which basic vibration of a first step and high vibration of a first step are repeated during a first unit time.

The MCU may control the vibration unit to vibrate with a second vibration pattern based on an input signal generated when an UP button included in the button unit is selected. The second vibration pattern is a vibration pattern in which basic vibration of a second step and high vibration of a second step are repeated during a second unit time. The second unit time is shorter than the first unit time.

The MCU may control the vibration unit to vibrate with a third vibration pattern based on an input signal generated when a DOWN button included in the button unit is selected. The third vibration pattern is a vibration pattern in which basic vibration of a third step and high vibration of a third step are repeated during a third unit time. The third unit time is longer than the first unit time.

The MCU may be configured such that a ratio of a basic vibration to a high vibration within a unit time is set to 2:1.

A circuit diagram required for controlling the vibration unit may include a resistor located in front of an output terminal.

The resistor may be implemented as a capacitor having capacitance of 22 μF.

In order to generate the first vibration pattern, the MCU may control the vibration unit to output a higher-step vibration than the basic vibration of the first step during a first time, based on an input signal generated when the button is selected.

The vibration unit may be a coin-type vibration motor.

The toothbrush head may be configured to be detachable, and an upper end of the toothbrush head may be curved toward one side surface.

It is to be understood that both the foregoing general description and the following detailed description of the present disclosure are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating an electric toothbrush for pets according to an embodiment of the present disclosure.

FIG. 2 is a view illustrating the electric toothbrush for pets according to an embodiment of the present disclosure.

FIG. 3 is a view illustrating a toothbrush head of the electric toothbrush for pets according to an embodiment of the present disclosure.

FIG. 4 is a view illustrating a replaceable toothbrush head of the electric toothbrush for pets according to an embodiment of the present disclosure.

FIG. 5 is a view illustrating an example of a cat for which the electric toothbrush for pets is used according to an embodiment of the present disclosure.

FIG. 6 is a graph illustrating an actual vibration pattern for cats.

FIG. 7 is a view illustrating a vibration pattern of the electric toothbrush for pets according to an embodiment of the present disclosure.

FIG. 8 is a view illustrating a vibration pattern of the electric toothbrush for pets according to another embodiment of the present disclosure.

FIG. 9 is a view illustrating a vibration pattern of the electric toothbrush for pets according to yet another embodiment of the present disclosure.

FIG. 10 is a table illustrating references of a vibration pattern of the electric toothbrush for pets according to yet another embodiment of the present disclosure.

FIG. 11 is a circuit diagram illustrating the electric toothbrush for pets according to an embodiment of the present disclosure.

### DESCRIPTION OF SPECIFIC EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Hereinafter, for convenience of description, it will be described that the companion animal or pet is a cat, but the scope of the present disclosure is not limited thereto, and it should be noted that the present disclosure can also be applied to various other kinds of animals other than the cats.

Methods for oral care for cats may include scaling at a veterinary hospital, various supplements (snacks) including toothpaste, and physical brushing.

Generally, the cost of scaling at a veterinary hospital is 150,000 won (W) on average, and the scaling effect only lasts about 3 weeks, and the veterinarian must use a general anesthetic to anesthetize the cat in order to scale the cat's teeth. Thus, instead of brushing the cat's teeth by a person who cares for the cat, it is practically impossible to get a scaling service for the cat from the veterinarian every three weeks.

In addition, when oral care of the cat is performed by feeding adjuvants or supplements including toothpaste, etc. to the cat as described above, there is a risk that health problems that may occur in the cat's liver or kidneys cannot be predicted when viewed in a long term.

Therefore, in reality, only physical brushing of the cat's teeth can be seen as the most correct dental care method for cats.

In particular, cats dislike having their teeth brushed. It is known that even a veterinary hospital nurse takes at least a month to learn to brush cats' teeth (See YouTube educational video and most veterinarians recommended). In fact, it is known that an ordinary person who is not an expert such as a veterinarian or nurse takes about a year to learn the cats' teeth brushing.

The electric toothbrush according to the present disclosure is configured to operate with cat-friendly vibration and have toothbrush bristles optimally designed for a mouth of the cat having a small head, so that the electric toothbrush can allow the cat to feel more comfortable brushing of their teeth.

In particular, unlike electric toothbrushes for humans, the electric toothbrush for pets is implemented to vibrate similarly to the purring of pets and thus operates with low vibration so that the cat can feel the movement of the low-vibration electric toothbrush comfortably.

Here, purring (e.g., English: purr, German: Schnurren, and French: ronronnement) is a hoarse sound produced by some animals such as cats and civets. Tones of such purring differ from species to species, and even within the same species. The purring sound is a low-frequency sound that occurs in both exhalation and inspiration during breathing. It is well known that such purring sounds make cats feel secure and comfortable. (References: https://www.bbc.com/future/article/20180724-the-complicated-truth-about-a-cats-purr, https://ryortho.com/breaking/i s-there-healing-power-in-a-cats-purr, http://vpbio.missouri.edu/faculty/LeslieLyons.html, https://petkeen.com/do-cat-purrs-have-healing-powers)

To this end, according to one embodiment of the present disclosure, the electric toothbrush for pets is characterized in that it vibrates at a specific frequency. Hereinafter, an electric toothbrush for pets that vibrates at a specific frequency will be described in detail.

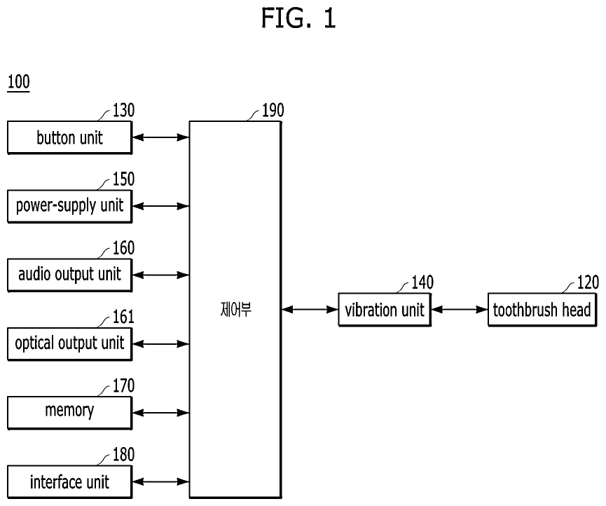

FIG. 1 is a block diagram illustrating an electric toothbrush for pets according to an embodiment of the present disclosure.

Referring to FIG. 1, an electric toothbrush 100 for pets (hereinafter referred to as an electric toothbrush) may include a toothbrush head 120, a button unit 130, a vibration unit 140, a power-supply unit 150, an audio output unit 160, an optical output unit 161, a memory 170, an interface unit 180, and a controller 190. Here, the above-described constituent elements shown in FIG. 1 may be implemented as physical hardware, and may also be implemented as modules corresponding to software for performing operations of the electric toothbrush 100. For example, the vibration unit 140 may represent a motor corresponding to hardware for actually vibrating the toothbrush head 120, and may also serve as a module controlled by the controller 190.

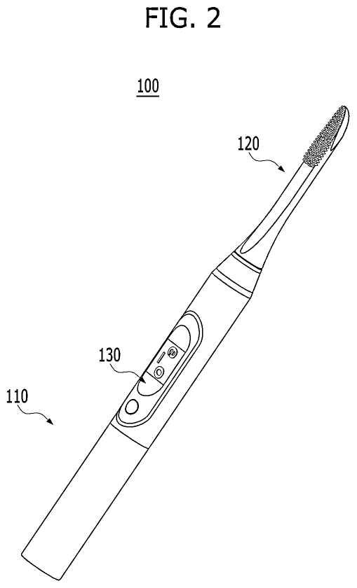

In more detail, the toothbrush head 120 may have an optimal structure capable of effectively removing a bacterial sac that may occur between the gums and teeth of the cat, and a detailed description thereof will be given later with reference to FIGS. 2 to 5.

The button unit 130 may receive various user commands related to the operation of the electric toothbrush 100, and may transmit a control signal corresponding to the received user command to the controller 190.

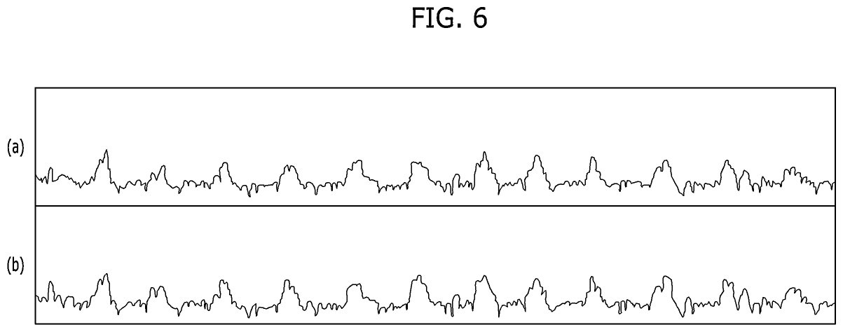

The vibration unit 140 may output a vibration pattern preferred by cats in order to solve the problems of the above-described electric toothbrush 100 for pets based on the control of the controller 190. Examples of the vibration unit 140 capable of outputting the vibration pattern preferred by cats will be described later with reference to FIGS. 6 to 10.

The power-supply unit 150 may supply the corresponding power to the electric toothbrush 100. For example, the power-supply unit 150 may include a converter (not shown) for converting AC power into DC power, and a DC/DC converter (not shown) for changing the level of DC power. On the other hand, the power-supply unit 150 may receive power from the outside, and may distribute power to the constituent components of the electric toothbrush 100. The power-supply unit 150 may use a method of supplying AC power by directly connecting to an external power source, or may be implemented to have a rechargeable battery. In the former case in which the method of supplying AC power by directly connecting to the external power source is used, since the power-supply unit 150 is connected to a wired cable, it is difficult to move the power-supply unit 150 from one place to another, and the movement range of the power-supply unit 150 is also limited. In the latter case in which the power-supply unit 150 including the rechargeable battery is used, whereas movement of the power-supply unit 150 becomes easier, the weight of the power-supply unit 150 may increase as much as the weight of the battery and the volume of the power-supply unit 150 may also increase as much as the volume of the battery, and the power-supply unit 150 should be directly connected to a power cable for a predetermined time for battery charging or should be combined with a charging cradle (not shown) for supplying power to the battery. The charging cradle may be connected to the electric toothbrush 100 through a terminal exposed to the outside, or a built-in battery included in the power-supply unit 150 may be recharged with electricity through wireless communication.

The audio output unit 160 may receive a signal processed by the controller 190 and output the processed signal as sound. For example, the audio output unit 160 may output a sound mapped in response to a signal generated when the user presses the physical button unit 130. For example, the audio output unit 160 may differently output the sound generated when the user presses the UP button and the sound generated when the user presses the DOWN button.

The optical output unit 161 may receive a signal processed by the controller 190 and output light. To this end, the optical output unit 161 may include a light emitting diode (LED) such as an LED lamp. The optical output unit 161 may be formed on an outer surface of the housing. In one embodiment, the optical output unit 161 may output light using the light emitting diode (LED) when the user selects the power button, the UP button, and the DOWN button. In addition, in one embodiment, the optical output unit 161 may output light based on the control of the controller 190, when the power-supply unit 150 is powered on or when the capacity of the built-in battery is completely consumed.

The memory 170 may store a program for processing and controlling each signal used in the controller 190, and may store a signal-processed data signal. For example, the memory 170 may store application programs designed for the purpose of performing various tasks that can be processed by the controller 190, and may selectively provide some of the stored application programs upon request of the controller 190. The program stored in the memory 170 is not specifically limited to being executed by the controller 190. Although the memory of FIG. 1 is provided separately from the controller 190, the scope of the present disclosure is not limited thereto, and the memory 170 may also be included in the controller 190 as needed. The memory 170 may include at least one of a volatile memory (e.g., DRAM, SRAM, SDRAM, etc.) and a non-volatile memory (e.g., flash memory, hard disk drive (HDD), solid state drive (SSD), etc.).

The interface unit 180 may serve as a path of connection to various kinds of external devices connected to the electric toothbrush 100. The interface unit 180 may include not only a wired method for transmitting/receiving data through a cable, but also a wireless method using the antenna. For example, the interface unit 180 may include a wireless communication unit (not shown) for short-range wireless communication with other electronic devices. Through the wireless communication unit (not shown), the interface unit 180 may exchange data with an adjacent mobile terminal. To this end, the interface unit 180 may include a communication module for short-range communication such as Wi-Fi, Bluetooth, Bluetooth low energy (BLE), ZigBee, Near Field Communication (NFC), and a communication module for cellular communication such as Long-Term Evolution (LTE), LTE-A (LTE Advanced), Code Division Multiple Access (CDMA), WCDMA(wideband CDMA), UMTS(universal mobile telecommunications system), WiBro(Wireless Broadband), etc.

The controller 190 may include at least one processor. In particular, in an embodiment of the present disclosure, the controller 190 may represent a Micro Controller Unit (MCU). In general, the conventional electric toothbrush for pets is often used to generate vibration using only a motor, and the electric toothbrush 100 according to the present disclosure is characterized in that an MCU is used to operate the following embodiments to be described later. The controller 190 may include at least one processor, and may control the overall operation of the electric toothbrush 100 using the processor included therein. Here, the processor may be a general processor such as a CPU. Of course, the processor may be a dedicated device such as an ASIC, or other hardware-based processors.

Meanwhile, the block diagram of the electric toothbrush 100 shown in FIG. 1 is disclosed only for illustrative purposes for one embodiment of the present disclosure, and the respective components of the electric toothbrush 100 shown in FIG. 1 can be integrated, added or omitted according to the specifications of the electric toothbrush 100 which is actually implemented.

That is, if necessary, two or more components may be combined into one component, or one component may be subdivided into two or more components. In addition, the functions performed in each block are intended to explain the embodiment of the present disclosure, and the specific operation or device does not limit the scope of the present disclosure.

FIG. 2 is a view illustrating the electric toothbrush for pets according to an embodiment of the present disclosure. Hereinafter, descriptions overlapping with the above-described content will be omitted for brevity.

Referring to FIG. 2, the electric toothbrush 100 for pets may include a housing 110 and a toothbrush head 120.

Here, the housing 110 may be formed of at least one of a synthetic resin material, a non-metal material, and a metal material, and may be constructed to have a cylindrical shape so that the user can easily hold (or grasp) the housing 110 by the user's hand. In addition, the outer surface of the housing 110 may be formed to have an anti-slip means capable of preventing the electric toothbrush 100 from slipping from the user's hand. In this case, the anti-slip means may be formed by covering either an uneven (concavoconvex) surface formed on the outer surface of the housing 110 or some portions of the housing 110 with high-elasticity rubber or silicon, etc.

In an embodiment, the housing 110 may form a handle (knob) of the electric toothbrush 100, and the button unit 130 may be provided at the center of the outer surface of the housing 110. In this case, the position of the button unit 130 may be disposed at a position where the user can easily manipulate the button unit 130 with his or her thumb while holding the housing 110 in one hand. In addition, although the button unit 130 of FIG. 2 is illustrated as a physical button for convenience of description, the scope of the present disclosure is not limited thereto, and it should be noted that the button unit 130 may also be implemented as a touch pad or the like.

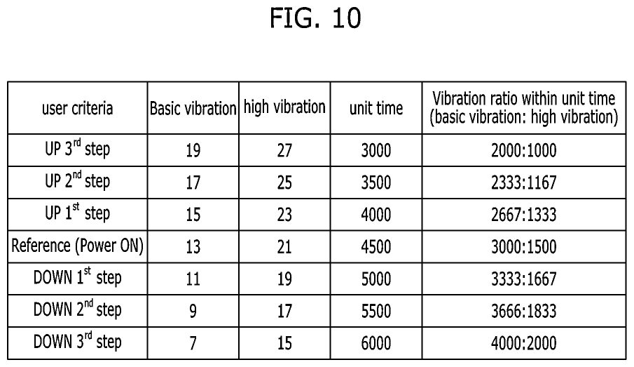

The button unit 130 may include the power button for turning the electric toothbrush 100 on or off, the UP button for increasing the intensity of vibration, and the DOWN button for decreasing the intensity of vibration. The button unit 130 is formed of silicone and has a waterproof structure. Here, when the user presses the power button, a reference vibration level established in the electric toothbrush 100 may be output from the electric toothbrush 100. When the user presses the UP button, a vibration level that is one step higher than a current vibration level may be output from the electric toothbrush 100. In addition, when the user presses the DOWN button, a vibration level that is one step lower than a current vibration level may be output from the electric toothbrush 100. A detailed description thereof will be given later in detail with reference to FIG. 10.

In an embodiment, the housing 110 may include a battery (not shown). The battery may be electrically connected to the button unit 130 formed on the outer surface of the housing 110 to selectively provide power to the vibration unit (not shown) through the button unit 130. In this case, the battery may be implemented as a replaceable battery or a rechargeable battery. In one embodiment, when the battery is implemented as a replaceable battery, a lower space portion of the housing 110 may form an opening communicating with the outside at a lower end thereof, thereby allowing the battery to enter and exit through the opening. In this case, the opening may be opened or closed by a stopper screwed to the lower end of the housing 110. In addition, in one embodiment, when the battery is implemented as a rechargeable battery, the stopper of the housing 110 may include a charging terminal electrically connected to the battery. In addition, a wall body for preventing movement of the battery may be formed in the lower space portion of the housing 110.

In one embodiment, an upper space portion of the housing 110 may include the vibration unit.

The vibration unit may be electrically connected to the battery to vibrate the toothbrush head 120 with the power provided from the battery. In this embodiment, a vibration shaft of the vibration unit may protrude outward from the upper space portion of the housing 110 so as to be connected to the toothbrush head 120. In this case, the vibration shaft may be formed in a circular, rectangular, or semicircular shape corresponding to an appropriate cross-section capable of transferring vibration to the toothbrush head 120. In this embodiment, the vibration unit may use a coin-type vibration motor rather than a rotary motor. Accordingly, the motor embedded in the vibration unit may operate to vibrate (or shake), so that the vibration unit can vibrate the toothbrush head 120 rather than rotating the toothbrush head 120.

Although not shown in the drawings, the inner surface of the upper space portion of the housing 110 may further include a soundproof unit.

Here, the soundproof unit may reduce noise generated by vibration of the vibration shaft. In more detail, the soundproof unit may construct a soundproofing structure by forming at least one soundproofing unevenness along the inner surface of the upper space portion of the housing 110. The soundproof unit may be formed of an elastic material such as rubber or silicon, and may include a wall body, the inner surface of which includes the soundproof unevenness. The soundproof unit forming the wall body may be installed along the inner surface of the upper space portion of the housing 110, thereby surrounding the vibration unit and the vibration shaft. Accordingly, noise generated by vibration of the vibration shaft of the vibration unit may be reduced by the soundproof unevenness of the soundproof unit surrounding the vibration unit and the vibration shaft. In this case, the soundproof unit may be configured such that a plurality of dot-shaped soundproofing uneven portions is continuously and repeatedly formed along the inner surface of the upper space portion of the housing, without being limited thereto. Alternatively, the soundproof unit may be configured such at a plurality of line-shaped soundproofing uneven portions is continuously and repeatedly formed in parallel to the inner surface of the upper space portion of the housing.

In addition, the toothbrush head 120 may be connected to the vibration shaft of the vibration unit. When vibration is generated by the vibration shaft of the vibration unit, the toothbrush head 120 may transfer the generated vibration without change.

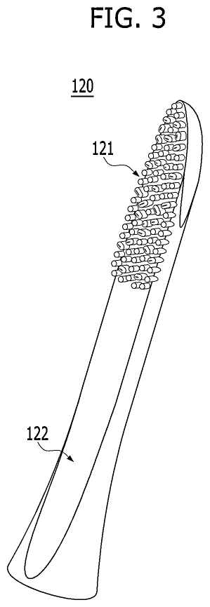

The toothbrush head 120 may include a support and bristles. The support and bristles may be formed integrally or separately. In this case, the support may be formed in a shape that a diameter of the support gradually decreases upward and the lower end of the support includes a coupling space in which the vibration shaft can be inserted and combined. In an embodiment, the toothbrush head 120 may be detachably coupled to the housing 110, so that the toothbrush head 120 can be periodically replaced with another. Also, the toothbrush head 120 can be sterilized by boiling alone, so that the electric toothbrush can be used hygienically. A detailed description of the toothbrush head 120 will be given later with reference to FIGS. 3 to 5.

FIG. 3 is a view illustrating the toothbrush head of the electric toothbrush for pets according to an embodiment of the present disclosure. Hereinafter, descriptions overlapping with the above-described content will be omitted for brevity.

Referring to FIG. 3, the toothbrush head 120 may include bristles 121 and a support 122, and may be formed of at least one of a synthetic resin material, a non-metal material, and a metal material.

The bristles 121 and the support 122 may be formed integrally, or the bristles 121 may be attached to the support 122. When the bristles 121 are configured to be attached to the support 122, only the bristles 121 may be separated.

In one embodiment, the bristles 121 may be formed of a silicone material so that the bristles 121 can be boiled for 100% sterilization. In addition, the bristles 121 may also be formed of a material such as nylon or PBT.

In one embodiment, the support 122 may be formed of a silicone material in the same manner as the bristles 121, or may be formed of a plastic material such as PP or SAN.

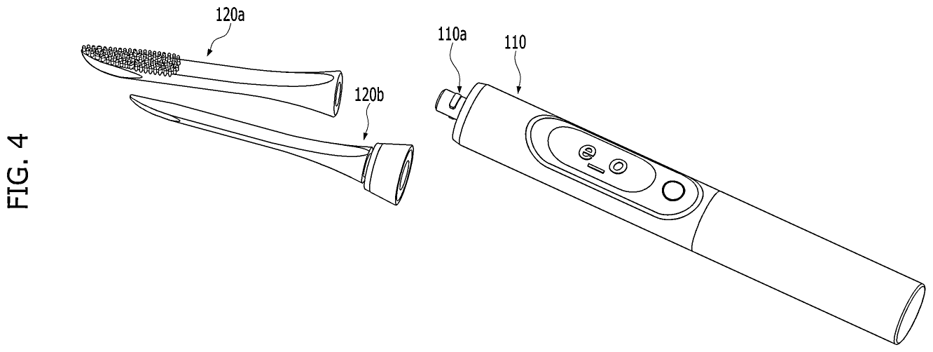

FIG. 4 is a view illustrating a replaceable toothbrush head of the electric toothbrush for pets according to an embodiment of the present disclosure. Hereinafter, descriptions overlapping with the above-described content will be omitted for brevity.

Referring to FIG. 4, the toothbrush heads 120a and 120b may be separated from the housing 110. In this case, the toothbrush heads 120a and 120b may be detachably coupled to an upper coupling portion 110a of the housing 110.

The upper coupling unit 110a of the housing 110 may be formed in a screw shape and coupled to the toothbrush heads 120a and 120b. Alternatively, the upper coupling unit 110a of the housing 110 may be formed in a shape such that the toothbrush heads 120a and 120b connected to each other can be inserted in the upper coupling unit 110a. To this end, the toothbrush heads 120a and 120b may form a coupling space therein.

Unlike the toothbrush head 120a shown in FIGS. 2 and 3, the head 120b of FIG. 4 may have a shape without bristles. That is, the head 120b of FIG. 4 may be detachably coupled to the housing 110 of the electric toothbrush 100, but the head 120b of FIG. 4 does not have bristles. Nevertheless, since the head 120b can be connected to the electric toothbrush 100, the head 120b may receive vibration generated by the electric toothbrush 100 and output the vibration. In this case, the user may use the electric toothbrush 100 for the purpose of providing a sense of stability to the cat, not for the purpose of brushing the cat's teeth.

Also, the toothbrush heads 120a and 120b may be replaced with a grooming comb or a face comb as needed. Similarly, the toothbrush heads 120a and 120b can transfer the vibration to the electric toothbrush 100 without change by connecting to the electric toothbrush 100. Thus, when the toothbrush heads 120a and 120b are replaced with the grooming comb or a face comb, the grooming comb or the face comb may output a cat-friendly vibration pattern without change. The user may contact the cat's chin or neck with the electric toothbrush 100 coupled to the grooming comb or face comb that outputs the cat-friendly vibration pattern, so that the cat can experience psychological stability.

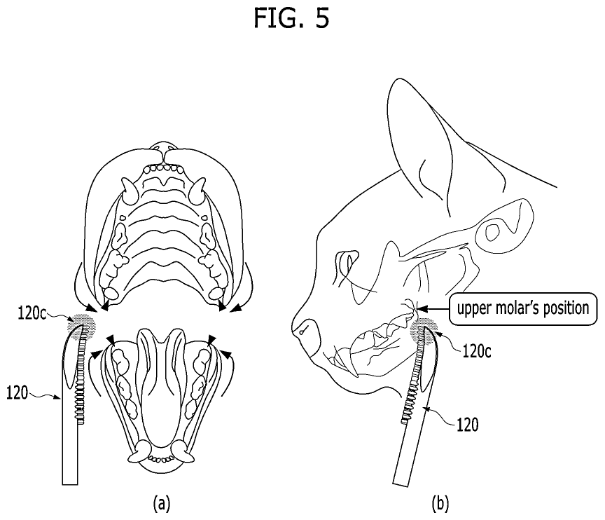

FIG. 5 is a view illustrating an example of the cat for which the electric toothbrush for pets is used according to an embodiment of the present disclosure. Hereinafter, descriptions overlapping with the above-described content will be omitted for brevity.

FIG. 5(a) shows upper and lower surfaces of the cat's mouth, and FIG. 5(b) shows a side surface of the cat's face.

In accordance with one embodiment of the present disclosure, when viewed from the side of the toothbrush head 120, the upper end portion 120c of the toothbrush head 120 is curved to one side, so that the toothbrush head 120 is suitable for brushing the cat's teeth.

Referring to FIG. 5(a), the end portion 120c of the toothbrush head 120 may be curved (or bent) to one side, thereby easily removing tartar from the cat's molars.

Likewise, the cat's upper molars are not visible from the outside, but are located deep inside the cat's mouth. The user can brush the upper molars using the end portion 120c of the toothbrush head 120.

FIG. 6 is a graph illustrating an actual vibration pattern for cats.

FIGS. 6(a) and 6(b) show graphs obtained when waveforms of different cat purring sounds are measured. At this time, although FIG. 6(a) and FIG. 6(b) are exemplary graphs for the purring sounds of two cats, it was confirmed that most cats produce a purring sound having a similar vibration pattern.

Referring to FIG. 6(a) and FIG. 6(b), it can be seen that the highest intensity of vibration generated by the cat's purring is about 2 to 3 times higher than the lowest intensity of vibration generated by the cat's purring. Based on such difference in vibration intensity between the different purring sounds, the electric toothbrush may output a vibration pattern to be output by mixing basic vibration and high vibration in a predetermined ratio. A detailed description thereof will be given later with reference to FIG. 10.

Similarly, the electric toothbrush according to an embodiment of the present disclosure may vibrate at a very low frequency. This is to similarly mimic a vibration pattern that makes the cat feel comfortable.

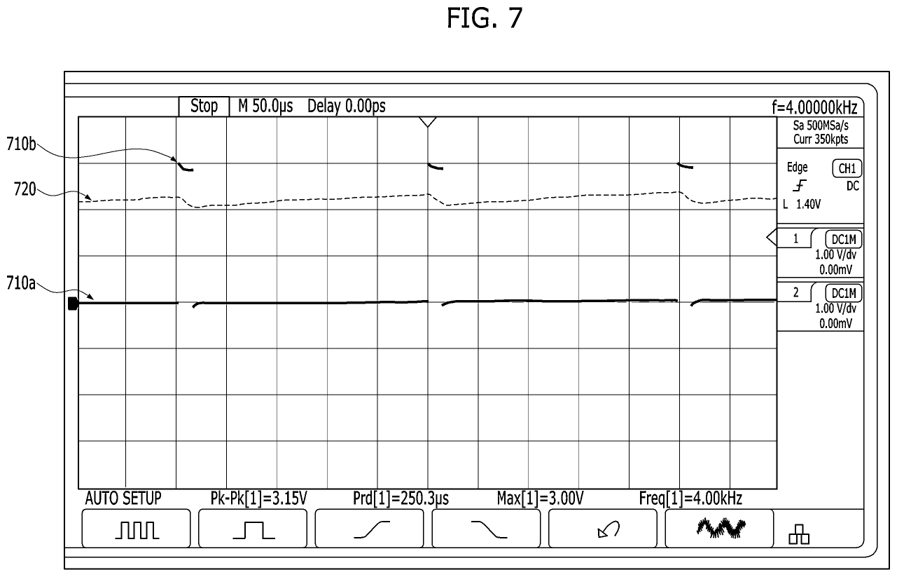

In order to mimic the purring sound actually produced by the cat, an embodiment of the present disclosure proposes methods as shown in FIGS. 7 to 9. Hereinafter, the operations of the electric toothbrush according to the present disclosure will be described with reference to oscilloscopic graphs showing vibration patterns shown in FIGS. 7 to 9. In FIGS. 7 to 9, a vertical axis of each oscilloscopic graph may represent time, and a horizontal axis of each oscilloscopic graph may represent voltage (one space of the horizontal axis represents one volt (1V).

FIG. 7 is a view illustrating examples of a vibration pattern of the electric toothbrush for pets according to an embodiment of the present disclosure. Hereinafter, descriptions overlapping with the above-described content will be omitted for brevity.

The operation method of the electric toothbrush according to the present disclosure is implemented by enabling the electric toothbrush to start vibrating when a positive(+) terminal and a negative(−) terminal of the coin-type vibration motor shown in the circuit diagram meet. In more detail, since the electric toothbrush uses the MCU, the electric toothbrush may output digital vibration patterns of 0 and 1 instead of outputting analog vibration patterns.

That is, since the electric toothbrush according to the present disclosure does not necessarily operate at a fixed voltage or less to adjust the voltage, the amount of electricity to be applied to the electric toothbrush can be adjusted by adjusting a duration time in which the positive(+) and negative(−) terminals of the motor meet each other.

Referring to FIG. 7, the first waveforms 710a and 710b may include a long-term vibration pattern 710a and a short-term vibration pattern 710b. Here, the long-term vibration pattern 710a is output from the negative(−) terminal of the motor, and the short-term vibration pattern 710b is output from the positive(+) terminal of the motor. That is, the long-term vibration pattern 710a may represent a state in which electricity does not flow in the electric toothbrush, and the short-term vibration pattern 710b may represent a state in which electricity flows in the electric toothbrush. In more detail, the short-term vibration pattern 710b depicted in the upper part of FIG. 7 may be generated when the positive(+) terminal and the negative(−) terminal of the motor are connected to each other, and the long-term vibration pattern 710a depicted in the lower part of FIG. 7 may be generated when the positive(+) terminal and the negative(−) terminal of the motor are disconnected from each other.

At this time, as described above with reference to FIG. 6, since the vibration pattern of the cat's purring sound has an analog vibration pattern, a discontinuous digital vibration as shown in the first waveforms 710a and 710b may make the cat psychologically uncomfortable.

In one embodiment, when a specific resistance is added to the electric toothbrush, the electric toothbrush may output the same vibration pattern as the second waveform 720, instead of outputting the digital vibration pattern of 0 and 1 at a point where the positive(+) terminal and the negative(−) terminal of the motor meet each other.

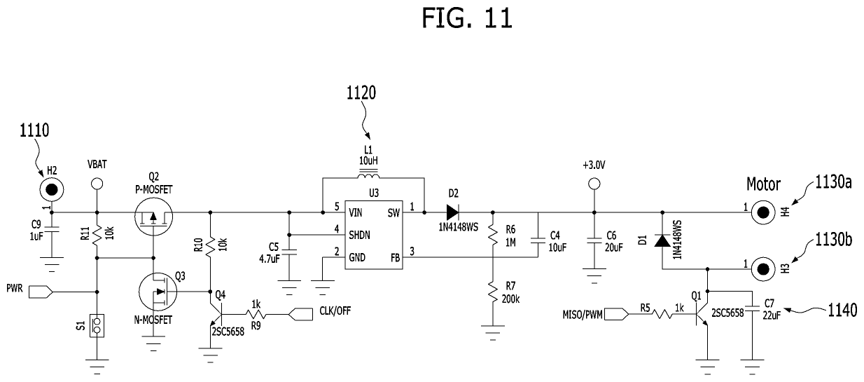

That is, the electric toothbrush according to the present disclosure may add a capacitor of 22 μF to the motor so as to output a vibration pattern similar to the analog vibration pattern indicating the purring sound of the cat. This will be described later in more detail with reference to the circuit diagram of FIG. 11.

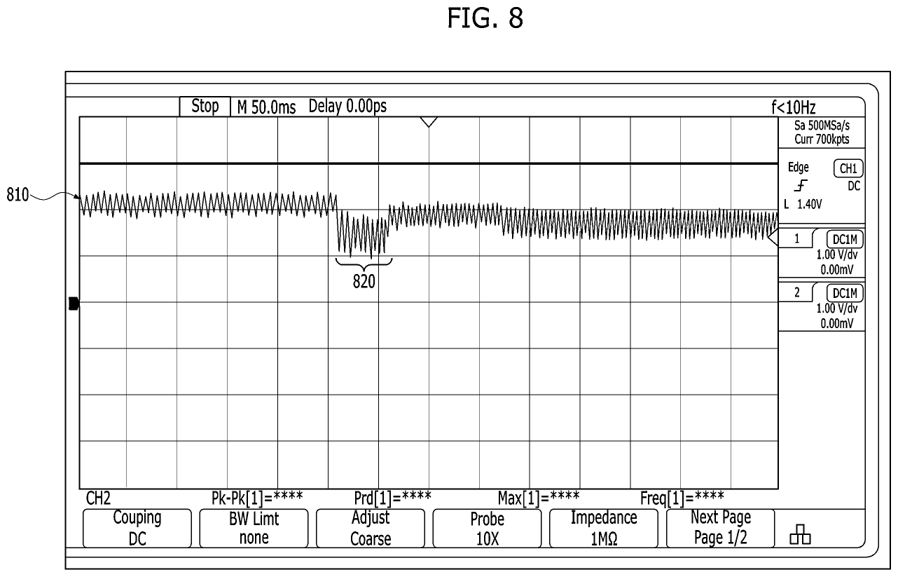

FIG. 8 is a view illustrating an example of a vibration pattern of the electric toothbrush for pets according to another embodiment of the present disclosure. Hereinafter, descriptions overlapping with the above-described content will be omitted for brevity.

In order to generate the first vibration pattern, the electric toothbrush may output a higher-intensity vibration than the basic vibration of the first step during a first time.

The most important thing in the electric toothbrush of the present disclosure is to provide a sense of stability to the cat by implementing low vibration similar to the purring sound of the cat. To this end, the electric toothbrush must enable the toothbrush head to operate with low vibration, but in general, the motor cannot be rotated at a low vibration frequency.

In order to solve this problem, the electric toothbrush according to the present disclosure is implemented to temporarily output a higher-intensity vibration than the selected vibration step, so that the electric toothbrush can use the motor even at a low vibration frequency.

Referring to FIG. 8, a first section 820 descending from the first waveform 810 may correspond to a time section in which the electric toothbrush outputs high vibration (or vibrates at a high vibration frequency) during a first time. In other words, as the waveform moves downward from the first waveform 810 of FIG. 8, the intensity of vibration (e.g., the vibration frequency) becomes higher. When the user presses the UP button of the electric toothbrush, the electric toothbrush can implement a desired vibration of the corresponding step by the method in which the first section 820 of the first waveform 810 is depicted to descend and then ascend again.

In addition, in order to implement higher-level vibration, the electric toothbrush according to the present disclosure may be controlled to more frequently connect the positive(+) terminal and the negative(−) terminal of the motor to each other as shown in FIG. 7, instead of rotating the motor by outputting a higher voltage. As a result, the first waveform 810 of FIG. 8 may further move downward in the first section 820, so that the electric toothbrush can implement higher vibration.

More specifically, the lowest motor speed that can be realized in a general electric toothbrush is set to 5 to 7. However, in reality, when the motor is powered on after the programmable motor speed was set to 5 to 7, it is impossible to vibrate the motor.

In order to solve this problem, when the motor speed is set to any value of 5 to 7 (e.g., when the user sets the basic vibration to the value of 8 by pressing the power button or the DOWN button), the electric toothbrush controls the motor speed to be set to the value of 19 during the first time (e.g., 0.01 sec or 0.1 sec), and then controls the vibration unit to output the value of 5 to 7 again. In this case, the value of 19 that has been set to the motor speed is high enough to rotate the motor, which may be determined differently according to hardware specifications. Similarly, the first time is the shortest time during which the motor can rotate, and may be determined differently according to hardware specifications.

Accordingly, the electric toothbrush according to the present disclosure may output low-intensity of vibration (hereinafter referred to as low vibration), unlike other electric toothbrushes.

When the output vibration of the electric toothbrush is at a high level, the electric toothbrush operating with high vibration can effectively remove food particles stuck between teeth and gums of the cat. When the output vibration of the electric toothbrush is at a low level, the electric toothbrush can effectively massage the gums of the cat. That is, as the electric toothbrush vibrates at a lower vibration frequency, the gums of the cat can be more effectively massaged.

Therefore, when the electric toothbrush according to the present disclosure vibrates the toothbrush head with low vibration intensity, the electric toothbrush can efficiently massage the gums of the cat even in a state where the bristles are not directly inserted into the cat's periodontal sacs. In particular, as described above, in dental lectures by the Veterinary Animals Dental Association, etc., it is recommended that the best way to brush cats' teeth is to shake the periodontal sacs (i.e., bacterial sacs between the cats' teeth and gums) for oral care of the cats.

In addition, a paper on the cat's oral care effect of the electric toothbrush operating at such low vibration intensity has also been published. It is also hypothesized that the cat's purring sound at a frequency of 25 to 35 Hz has healing and analgesic effects on bones, tendons, and ligaments of cats. That is, in order to solve teeth and gum pain and musculoskeletal problems of some kinds of cats from among feline animals, a method for controlling the electric toothbrush to vibrate at a frequency where the cats can be psychologically calmed down has also been published (Reference Papers: Joelle Dehasse, “Vivre avec un chat”. Tout sur la psychologie du chat. Odile Jacob. Pp. 602. ISBN 2-7381-1603-5).

Therefore, the electric toothbrush according to the present disclosure is designed to shake the gums of the cat in an operation mode of low vibration instead of movement of a human hand. Accordingly, the low vibration output from the electric toothbrush may improve functional effects of the cat's teeth brushing, and may make the cat psychologically comfortable.

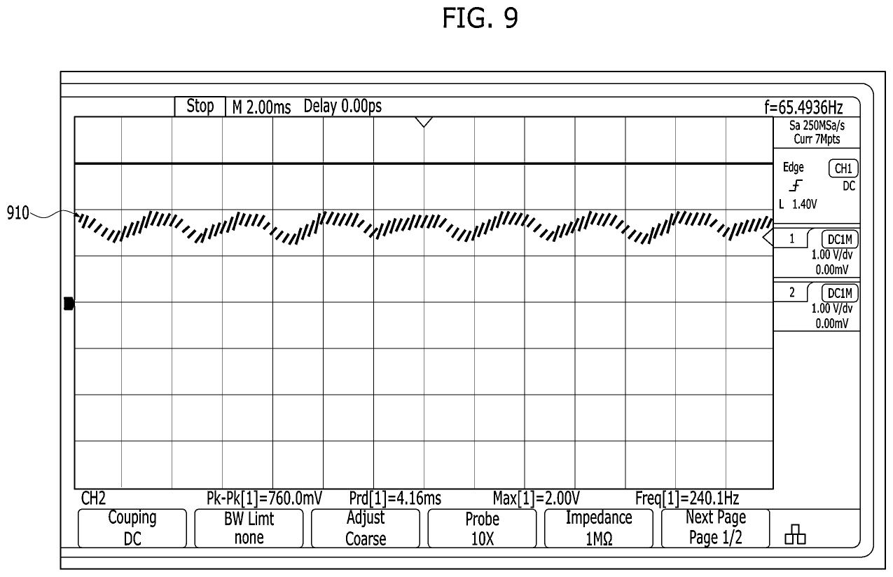

FIG. 9 is a view illustrating examples of a vibration pattern of the electric toothbrush for pets according to yet another embodiment of the present disclosure. Hereinafter, descriptions overlapping with the above-described content will be omitted for brevity.

Referring to FIG. 9, the first waveform 910 represents an oscilloscopic graph illustrating a vibration pattern output by the electric toothbrush according to the embodiment of FIGS. 7 and 8.

In accordance with one embodiment, in order to output a vibration pattern similar to the purring sound of the cat as shown in FIG. 6, the embodiments of FIGS. 7 and 8 can be applied to the vibration unit.

Accordingly, it can be seen that the first waveform 910 of FIG. 9 is output similarly to the vibration pattern generated by the cat's purring shown in FIG. 6.

FIG. 10 is a table illustrating references of a vibration pattern of the electric toothbrush for pets according to yet another embodiment of the present disclosure. Hereinafter, descriptions overlapping with the above-described content will be omitted for brevity.

Referring to FIG. 10, the user may determine the intensity of vibration generated by the electric toothbrush using the power button, the UP button, and the DOWN button included in the button unit of the electric toothbrush.

The table shown in FIG. 10 shows various criteria of the intensity and increase rate of vibrations output from the electric toothbrush according to the user's manipulation. Here, the intensity of vibration may be determined based on the speed of the motor included in the vibration unit. In addition, the intensity of vibration of the electric toothbrush and the stepwise increase rate of such vibration may be determined by the manufacturer of the electric toothbrush. That is, the intensity of vibration of the electric toothbrush may vary according to specifications of hardware (e.g., a motor, etc.) for implementing such vibration.

In this case, the numbers written in the table of FIG. 10 are code values of the program used in the controller, and are not absolute numbers, but may refer to relative numbers. For example, the number “13” corresponding to the basic vibration may correspond to a code value of the program used in the electric toothbrush of the present disclosure. However, the number “13” shown in FIG. 10 may represent at least one of the intensity of vibration output from the vibration unit, the intensity of vibration generated by the motor, and the speed of the motor. In addition, the unit time “4000” shown in FIG. 10 may refer to about 1 second.

The electric toothbrush according to the present disclosure may output the intensity of vibration ranging from 7 to 27. In general, the intensity of vibration ranging from 7 to 11 may be suitable for timid cats, the intensity of vibration ranging from 9 to 13 may be suitable for normal cats, and the intensity of vibration ranging from 11 to 15 may be suitable for joyful cats, and the intensity of vibration ranging from 13 to 17 may be suitable for excited cats. This is because, in fact, when the cat feels comfortable, the cat verbally makes low vibration corresponding to the purring sound with a low-level slow beat, and as the cat gets more excited, the cat verbally makes higher vibration corresponding to loud and higher-frequency sound. In this case, the intensity of vibration ranging from 7 to 27 may include all of the surface area intensities of vibrations corresponding to the cat's purring sound.

In this embodiment, the electric toothbrush may set the ratio of basic vibration to high vibration within a unit time to 2:1. This is because, when the MCU of the electric toothbrush sets the ratio of the basic vibration to the high vibration to 2:1, the value of the vibration pattern actually output from the toothbrush head corresponds to the ratio (1:1) of the basic vibration to high vibration. The reason why the ratio of the basic vibration to high vibration in the actual vibration pattern output from the toothbrush head becomes 1:1 is that, when the high intensity of vibration is output from the toothbrush head, it takes a predetermined time to reduce the intensity of vibration again.

In addition, the electric toothbrush may set the unit time to a shorter unit time as the intensity of vibration increases stepwise from a low-step vibration to a high-step vibration. For example, whereas the unit time for use in the DOWN 3^{rd} step of FIG. 10 is set to 6000 (about 1.5 seconds), the unit time for use in the UP 3^{rd} step of FIG. 10 may correspond to 3000 (about 0.75 seconds). In detail, during the DOWN 3^{rd} step, the electric toothbrush may vibrate at the basic vibration value of 7 for 1 second during the unit time of about 1.5 seconds, and may vibrate at the high vibration value of 15 for 0.5 seconds. During the UP 3^{rd} step, the electric toothbrush may vibrate at the basic vibration value of 19 for 0.5 seconds during the unit time of about 0.75 seconds, and may vibrate at the high vibration value of 27 for 0.25 seconds.

Accordingly, as the vibration step increases in level, the unit time becomes shorter, and the intensity of vibration becomes stronger. Therefore, the electric toothbrush according to the present disclosure can produce the purring sound differently according to the above-described different levels of the cat's emotional excitement as shown in FIG. 6.

A method for allowing the user to manipulate the electric toothbrush based on various user criteria will hereinafter be described with reference to the table of FIG. 10.

When the user presses the power button of the electric toothbrush to turn on the electric toothbrush, the electric toothbrush may operate the vibration unit with the basic vibration of 13 or the high vibration of 21. At this time, the electric toothbrush may set the operation period in which the electric toothbrush operates with the basic vibration of 13 and the high vibration of 21 to 4500. In accordance with the above-described embodiment, the electric toothbrush may output the basic vibration of 13 during the time period of 3000, and may output the high vibration of 21 during the time period of 1500.

In one embodiment, if the user presses the power button of the electric toothbrush to turn on the electric toothbrush and then presses the UP button to increase the vibration intensity of the electric toothbrush, the electric toothbrush may operate the vibrating unit with the basic vibration of 15 and the high vibration of 23. In this case, the electric toothbrush may output the basic vibration of 15 for a time period corresponding to 2667, and may output the high vibration of 23 for a time period corresponding to 1333.

In another embodiment, if the user presses the power button of the electric toothbrush to turn on the electric toothbrush and then presses the DOWN button of the electric toothbrush to reduce the vibration intensity of the electric toothbrush, the electric toothbrush may operate the vibration unit with the basic vibration of 11 and the high vibration of 19. In this case, the electric toothbrush may output the basic vibration of 11 for a time period corresponding to 3333, and may output the high vibration of 19 for a time period corresponding to 1667.

When the user additionally presses the UP button or the DOWN button, the electric toothbrush can operate in the same manner as described above, and a detailed description thereof will herein be omitted for brevity.

FIG. 11 is a circuit diagram illustrating the electric toothbrush for pets according to an embodiment of the present disclosure. Hereinafter, descriptions overlapping with the above-described content will be omitted for brevity.

Referring to FIG. 11, power may be applied to the electric toothbrush through a first input terminal 1110. Here, the power applied to the electric toothbrush may correspond to 1.5 V. In one embodiment, the electric toothbrush may use an AAA battery as a built-in battery.

The power applied to the electric toothbrush through the first input terminal 1110 may increase up to 3 volts (3V) after passing through a voltage ascending unit 1120 having an inductor L1, so that the resultant power may be transmitted to the output terminals 1130a and 1130b connected to the motor.

In one embodiment, the electric toothbrush sets the first output terminal 1130a of the motor to the positive(+) terminal and sets the second output terminal 1130b to the negative(−) terminal, so that the electric toothbrush can control the motor to output vibration when the first output terminal 1130a and the second output terminal 1130b meet each other. That is, as described above, the electric toothbrush according to the present disclosure may adjust the intensity step of vibration by adjusting how many times the first output terminal 1130a and the second output terminal 1130b of the motor are in contact with each other, instead of adjusting the intensity step of vibration by adjusting the intensity of voltage. As described above, the electric toothbrush can increase the intensity level of vibration by making the first output terminal 1130a and the second output terminal 1130b of the motor meet more frequently.

In one embodiment, the circuit diagram for implementing the vibration unit of the electric toothbrush may include a resistor 1140 located in front of the output terminals 1130a and 1130b of the motor. As a result, the vibration unit of the electric toothbrush can implement the analog vibration pattern similar to the cat's purring sound, instead of implementing the digital vibration pattern of 0 and 1 generated when the motor is connected to or disconnected from the positive(+) and negative(−) terminals of the output terminals 1130a and 1130b.

For example, the circuit diagram for implementing the vibrating unit of the electric toothbrush may further include a capacitor 1140 having capacitance of 22 μF so that the capacitor 1140 can be disposed in front of the output terminals 1130a and 1130b of the motor. However, the capacitor 1140 having the capacitance of 22 μF corresponds to an optimum resistor appropriate for the experimental result, the scope of the present disclosure is not limited thereto, and it should be noted that resistors having other capacitances may also be included in the embodiments of the present disclosure.

That is, a general electric toothbrush need not be implemented to operate with low vibration intensity, and the vibration pattern of the general electric toothbrush need not be implemented in an analog manner, so that there is no reason why any resistor is added to the front stage of the output terminals 1130a and 1130b. On the other hand, the electric toothbrush is characterized in that a resistor is added at the front stage of the output terminals 1130a and 1130b in order to implement a cat-friendly vibration pattern.

The constituent components of the electric toothbrush for pets according to the embodiments described with reference to FIGS. 1 to 11 may be implemented by hardware, software, firmware, or a combination thereof including one or more processors coupled to the memory. The constituent components of the device according to the embodiments may be implemented as one chip, for example, one hardware circuit. Further, the constituent components of the electric toothbrush for pets according to the embodiments may be implemented as separate chips, respectively. Further, at least one of the components of the electric toothbrush for pets according to the embodiments may include one or more processors capable of executing one or more programs, and the one or more programs may include instructions required for performing one or more of the operations/methods of the electric toothbrush shown in FIGS. 1 to 11.

Although the respective drawings have been described separately for convenience of description, the embodiments described in the drawings may be merged to implement a new embodiment as necessary. In addition, according to the needs of those skilled in the art, the operation of designing a computer-readable recording medium in which a program for executing the previously described embodiments is recorded is also within the scope of the embodiments. The apparatus according to the embodiments is not limited to the configuration and methods of the above-described embodiments, but the embodiments may be configured by selectively combining all or some of the embodiments so that various modifications can be made. Although the exemplary embodiments of the present disclosure have been disclosed for illustrative purposes, those skilled in the art will appreciate that various modifications, additions and substitutions are possible, without departing from the scope and spirit of the disclosure as disclosed in the accompanying claims. Such modifications should not be understood individually from the technical spirit or prospect of the present disclosure. In this specification, both apparatuses and methods are disclosed and descriptions of both of the apparatuses and methods may be complementarily applied to each other as needed.

Various constituent components of the apparatus according to the embodiments may be implemented by hardware, software, firmware, or a combination thereof. The constituent components of the apparatus according to the embodiments may be implemented as one chip, for example, one hardware circuit. Further, the constituent components of the apparatus according to the embodiments may be implemented as separate chips, respectively. Further, at least one of the components of the apparatus according to the embodiments may include one or more processors capable of executing one or more programs, and the one or more programs may include instructions required for performing one or more of the operations/methods of the embodiments.

In this document, “/” and “,” should be interpreted to indicate “and/or”. For instance, the expression “A/B” may mean “A and/or B”. Further, “A, B” may mean “A and/or B”. In addition, “A/B/C” may mean “at least one of A, B, and/or C”. Further, “A, B, C” may mean “at least one of A, B, and/or C.” Further, in the document, the term “or” should be interpreted to indicate “and/or”. For instance, the expression “A or B” may comprise 1) only A, 2) only B, and/or 3) both A and B. In other words, the term “or” in this document should be interpreted to indicate “additionally or alternatively”.

Although the terms first, second, etc. are used to describe various elements of the embodiments, these elements should not be limited by these terms. These terms are only used to distinguish one element from another. For example, a first user input signal may be referred to as a second user input signal. Similarly, the second user input signal may be referred to as a first user input signal. Use of such terms should be interpreted as not departing from the scope of the various embodiments. The first user input signal and the second user input signal are both user input signals, but do not mean the same user input signals unless clearly indicated in context.

The terminology used in the description of the embodiments herein is for the purpose of describing particular embodiments only and is not intended to be limiting. As used in the description of the various described embodiments and the appended claims, singular forms are intended to include plural forms as well, unless the context clearly indicates otherwise. The term “and/or” as used herein refers to and encompasses any and all possible combinations of one or more of the associated listed items. The term “includes” specifies the presence of stated features, numbers, steps, elements, and/or components, but does not preclude the presence or addition of one or more other features, numbers, steps, elements, and/or components thereof. A conditional expression such as “when\tilde{ }” or “if\tilde{ }” used in the description of the embodiments is not limitedly interpreted only as an optional case. Rather, the conditional expression has been intended such that a related operation may be performed or related definition may be interpreted when a specific condition is satisfied or in response to a specific condition.

As is apparent from the above description, the electric toothbrush according to the embodiments of the present disclosure can allow pets who do not like to have their teeth brushed to feel more comfortable brushing of their teeth.

According to one embodiment of the present disclosure, the electric toothbrush is implemented to operate with low vibration intensity, such that this low-vibration electric toothbrush can help treat the gums of pets.

According to one embodiment of the present disclosure, the electric toothbrush can provide psychological stability to pets at moments when they may feel anxious, such as visiting a veterinary hospital.

It will be apparent to those skilled in the art that various modifications and variations can be made in the present disclosure without departing from the spirit or scope of the inventions. Thus, it is intended that the present disclosure covers the modifications and variations of this invention provided they come within the scope of the appended claims and their equivalents.

What is claimed is:

1. An electric toothbrush for pets comprising:
a housing configured to have a button unit;
a power-supply unit configured to supply power;
a toothbrush head connected to the housing;
a vibration unit configured to vibrate the toothbrush head using the supplied power; and
a Micro Controller Unit(MCU) configured to control the vibration unit,
wherein the MCU controls the vibration unit to vibrate with a first vibration pattern, based on an input signal generated when a button included in the button unit is selected.

2. The electric toothbrush for pets according to claim 1, wherein:
the first vibration pattern is a vibration pattern in which basic vibration of a first step and high vibration of a first step are repeated during a first unit time.

3. The electric toothbrush for pets according to claim 2, wherein:
the MCU controls the vibration unit to vibrate with a second vibration pattern based on an input signal generated when an UP button included in the button unit is selected,
wherein the second vibration pattern is a vibration pattern in which basic vibration of a second step and high vibration of a second step are repeated during a second unit time,
wherein the second unit time is shorter than the first unit time.

4. The electric toothbrush for pets according to claim 2, wherein:
the MCU controls the vibration unit to vibrate with a third vibration pattern based on an input signal generated when a DOWN button included in the button unit is selected,
wherein the third vibration pattern is a vibration pattern in which basic vibration of a third step and high vibration of a third step are repeated during a third unit time,
wherein the third unit time is longer than the first unit time.

5. The electric toothbrush for pets according to claim 1, wherein:
the MCU is configured such that a ratio of a basic vibration to a high vibration within a unit time is set to 2:1.

6. The electric toothbrush for pets according to claim 1, wherein:
a circuit diagram required for controlling the vibration unit includes a resistor located in front of an output terminal.

7. The electric toothbrush for pets according to claim 6, wherein:
the resistor is implemented as a capacitor having capacitance of 22 μF.

8. The electric toothbrush for pets according to claim 2, wherein:
in order to generate the first vibration pattern,
the MCU controls the vibration unit to output a higher-step vibration than the basic vibration of the first step during a first time, based on an input signal generated when the button is selected.

9. The electric toothbrush for pets according to claim 1, wherein:
the vibration unit is a coin-type vibration motor.

10. The electric toothbrush for pets according to claim 1, wherein:
the toothbrush head is configured to be detachable, and an upper end of the toothbrush head is curved toward one side surface.
